(19) United States
(12) Patent Application Publication
(10) Pub. No.: US 2022/0099173 A1
(43) Pub. Date: Mar. 31, 2022

(54) TRANSMISSION AND ALL-TERRAIN VEHICLE HAVING SAME

(71) Applicant: SEGWAY TECHNOLOGY CO., LTD., Changzhou (CN)

(72) Inventor: Changwu ZOU, Changzhou (CN)

(21) Appl. No.: 17/484,071

(22) Filed: Sep. 24, 2021

(30) Foreign Application Priority Data
Sep. 28, 2020 (CN) 202022175164.1
Sep. 28, 2020 (CN) 202022177721.3

(51) Int. Cl. F16H 57/04; B60K 17/08; F16H 57/031

(52) U.S. Cl. CPC F16H 57/0416; F16H 2057/02043; F16H 57/031; B60K 17/08

(57) ABSTRACT

The disclosure relates to a transmission and all-terrain vehicle having the same. The transmission includes a casing body defining an air inlet and an air outlet; a casing cover mounted to the casing body, the casing cover and the casing body cooperatively defining a cavity in communication with the air inlet and the air outlet separately; and a transmission mechanism having at least a part provided in the cavity.

### CROSS-REFERENCE TO RELATED APPLICATION

This application is based on and claims priority to Chinese Patent Application Serial No. 202022175164.1, filed on Sep. 28, 2020, and Chinese Patent Application Serial No. 202022177721.3, filed on Sep. 28, 2020, the entire content of which are incorporated herein by reference.

### FIELD

The present disclosure relates to the field of vehicle technologies, and more particularly to a transmission and an all-terrain vehicle having the same.

### BACKGROUND

In the related art, vehicles usually are provided with a transmission. The transmission generally includes a casing body and a casing cover. The transmission has an air inlet and an air outlet, and the air inlet and the air outlet are provided to the casing body and the casing cover respectively such that pipelines of vehicles also need to be coupled to the casing body and the casing cover respectively. Hence, the pipelines have low concentration and a complicated arrangement, reducing space utilization of the vehicles.

In addition, the transmission is generally used to adjust the speed. During driving the vehicles, the transmission has a risk of temperature rise, and the temperature of the transmission cannot be detected. This is adverse to adjustment of operational state of the vehicle itself, increases probability of failure of the vehicle, and increases the risk of driving.

### SUMMARY

Embodiments of the present disclosure seek to solve at least one of the problems existing in the related art.

Embodiments of the present disclosure proposes a transmission. The transmission includes a casing body, a casing cover and a transmission mechanism. The casing body defines an air inlet and an air outlet. The casing cover is mounted to the casing body, and the casing cover and the casing body cooperatively define a cavity in communication with the air inlet and the air outlet separately. The transmission mechanism has at least a part provided in the cavity.

Embodiments of the present disclosure further proposes a transmission. The transmission includes a transmission casing, a transmission mechanism, an air outlet straight pipe, and a temperature detection device. The transmission casing defines a cavity therein and defines an air inlet and an air outlet in communication with the cavity. The transmission mechanism has at least a part provided in the cavity. The air outlet straight pipe is coupled to the air outlet of the transmission casing. The temperature detection device includes a temperature-sensing probe, and the temperature-sensing probe is inserted into at least one of the air outlet straight pipe and the cavity.

Embodiments of the present disclosure proposes an all-terrain vehicle. The all-terrain vehicle includes a power device, a transmission and a controller. The transmission includes a transmission casing, a transmission mechanism, an air outlet straight pipe, and a temperature detection device.

The transmission casing defines a cavity therein and defines an air inlet and an air outlet in communication with the cavity. The transmission mechanism has at least a part provided in the cavity. The air outlet straight pipe is coupled to the air outlet of the transmission casing. The temperature detection device includes a temperature-sensing probe, and the temperature-sensing probe is inserted into at least one of the air outlet straight pipe and the cavity. The controller is communicated with the power device and the temperature detection device separately.

Additional aspects and advantages of embodiments of present invention will be given in part in the following descriptions, become apparent in part from the following descriptions, or be learned from the practice of the embodiments of the present invention.

### BRIEF DESCRIPTION OF THE DRAWINGS

These and other aspects and advantages of embodiments of the present disclosure will become apparent and more readily appreciated from the following descriptions made with reference to the drawings, in which:

FIG. 1 is an exploded view of a transmission according to an embodiment of the present disclosure.

FIG. 2 is an exploded view of a transmission casing according to an embodiment of the present disclosure.

FIG. 3 is a structural schematic view of a casing body of a transmission according to an embodiment of the present disclosure.

FIG. 4 is another structural schematic view of a casing body of a transmission according to an embodiment of the present disclosure.

FIG. 5 is a side elevation view of an all-terrain vehicle according to an embodiment of the present disclosure with a partially enlarged view illustrating a transmission and a power device of the all-terrain vehicle.

FIG. 6 is a top plan view of an all-terrain vehicle according to an embodiment of the present disclosure with a partially enlarged view illustrating a transmission and a power device of the all-terrain vehicle.

### DETAILED DESCRIPTION

Embodiments of the present disclosure are described in detail below, and the embodiments described with reference to the accompanying drawings are illustrative. Embodiments of the present disclosure are described in detail below.

In the specification of the present disclosure, it is to be understood that terms such as “central,” “length,” “width,” “thickness,” “upper,” “lower,” “vertical,” “horizontal,” “top,” “bottom,” “inner,” “outer.” “clockwise,” “counterclockwise,” “axial,” “radial” and “circumferential” should be construed to refer to the orientation as then described or as shown in the drawings under discussion.

These relative terms are for convenience of description and do not require that the present disclosure be constructed or operated in a particular orientation.

In the description of the present disclosure, “a plurality of” means two or more than two.

A transmission 100 according to embodiments of the present disclosure is described below with reference to the accompanying drawings.

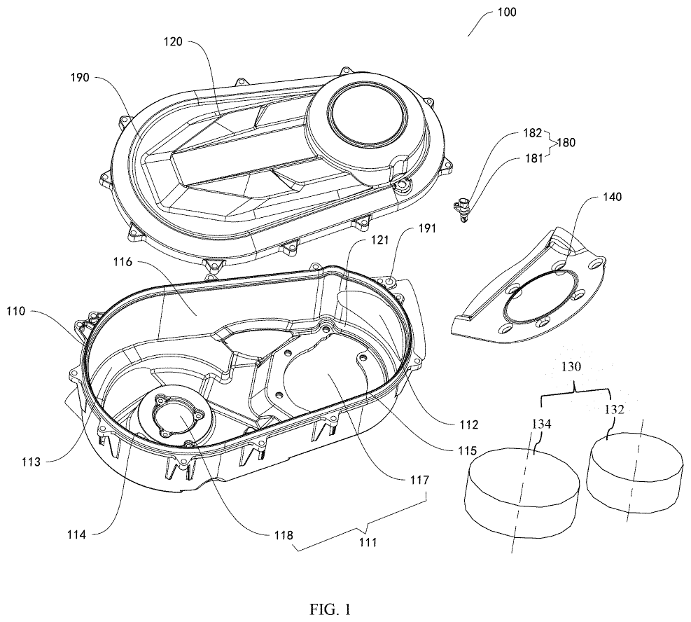

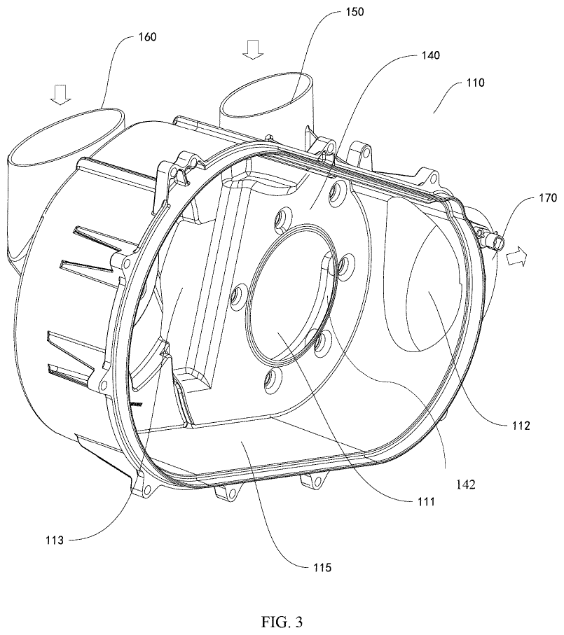

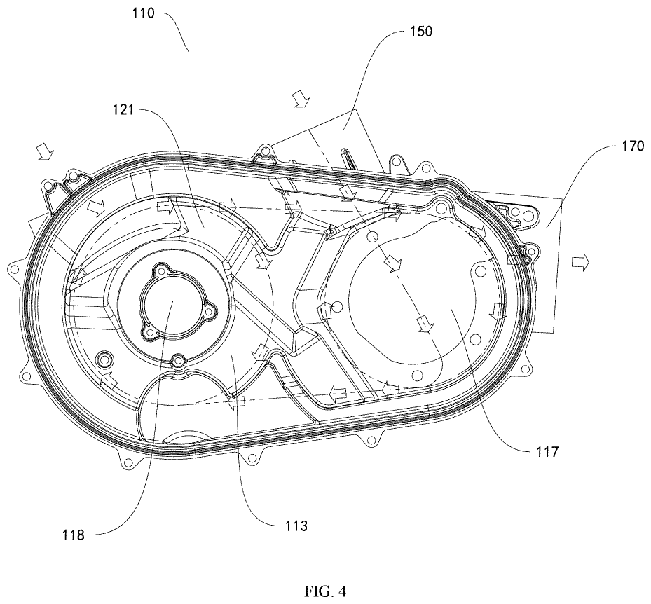

As illustrated in FIGS. 1 to 4 (arrows in FIGS. 3 and 4 indicating flow direction of air), the transmission 100 according to embodiments of the present disclosure includes a casing body 110, a casing cover 120 and a transmission mechanism 130.

The casing body 110 defines an air inlet 111 and an air outlet 112, the casing cover 120 is mounted to the casing body 110, and the casing cover 120 and the casing body 110 cooperatively defines a cavity 121. The cavity 121 is in communication with the air inlet 111 and the air outlet 112 separately, and at least a part of the transmission mechanism 130 is provided in the cavity 121. The casing body 110 and the casing cover 120 cooperatively constitute a transmission casing 190.

In the transmission 100 according to embodiments of the present disclosure, the casing body 110 defines the air inlet 111 and the air outlet 112. Compared to a transmission in the related art in which an air inlet and an air outlet are defined in a casing body and a casing cover of the transmission respectively, i.e., one of the air inlet and the air outlet is defined in the casing body and the other is defined in the casing cover, the transmission 100 according to embodiments of the present disclosure integrates the air inlet 111 and the air outlet 112 into the casing body 110, i.e., the air inlet 111 and the air outlet 112 are both defined in the casing body 110 such that pipelines in a vehicle coupled to the air inlet 111 and the air outlet 112 of the transmission 100 are coupled to the casing body 110, arrangement of the pipelines is simple and convenient, and the location of the pipelines are more concentrated, to facilitate improving space utilization of the vehicle.

Moreover, the casing cover 120 is mounted to the casing body 110, and the casing cover 120 and the casing body 110 cooperatively define the cavity 121; the cavity 121 is in communication with the air inlet 111 and the air outlet 112 separately, and at least a part of the transmission mechanism 130 is provided in the cavity 121. Thus, provision of the transmission mechanism 130 can facilitate achievement of speed change of the vehicle, and complete normal operation of the vehicle. Furthermore, at least a part of the transmission mechanism 130 is provided in the cavity 121, and the cavity 121 is in communication with the air inlet 111 and the air outlet 112 separately. Thus, air flow efficiency of the cavity 121 can be promoted, reduction in operational temperature of the transmission mechanism 130 can be facilitated, and reliability of the vehicle can be improved.

In addition, since the casing cover 120 may be coupled with no pipeline, in some cases only the casing cover 120 needs to be detached for works such as post-maintenance, leading to more convenient operation.

In this way, the air inlet 111 and the air outlet 112 of the transmission 100 according to embodiments of the present disclosure are integrated into the casing body 110, facilitating simplification of pipeline arrangement of the vehicle and improvement of pipeline concentration and space utilization of the vehicle.

In some embodiments of the present disclosure, as illustrated in FIG. 1, the transmission 100 may be further provided with a temperature detection device 180, and the temperature detection device 180 may be mounted to the transmission casing 190. Moreover, the temperature detection device 180 includes a temperature-sensing probe 181, and the temperature-sensing probe 181 may be inserted into the cavity 121. The temperature in the cavity 121 can be detected in real time by the temperature-sensing probe 181, and the temperature detection device 180 can feed back the detected temperature condition in the cavity 121 to a controller 300, such as an electronic control unit (ECU) such that the electronic control unit can adjust operation state of the vehicle. For example, when the temperature in the cavity 121 is too high, the electronic control unit may control an engine of the vehicle to stop or reduce its speed, to reduce the temperature in the cavity 121 and improve driving safety. Thus, the provision of the temperature-sensing probe 181 can facilitate adjustment of operational state of the vehicle itself, reduce probability of failure of the vehicle, and improve driving safety.

According to some embodiments of the present disclosure, the temperature detection device 180 is located at the air outlet 112, that is, the temperature detection device 180 can detect temperature at the location of the air outlet 112. Thus, by detecting temperature at the location of the air outlet 112, temperature state in the transmission 100 can be better determined, further facilitating control of the vehicle.

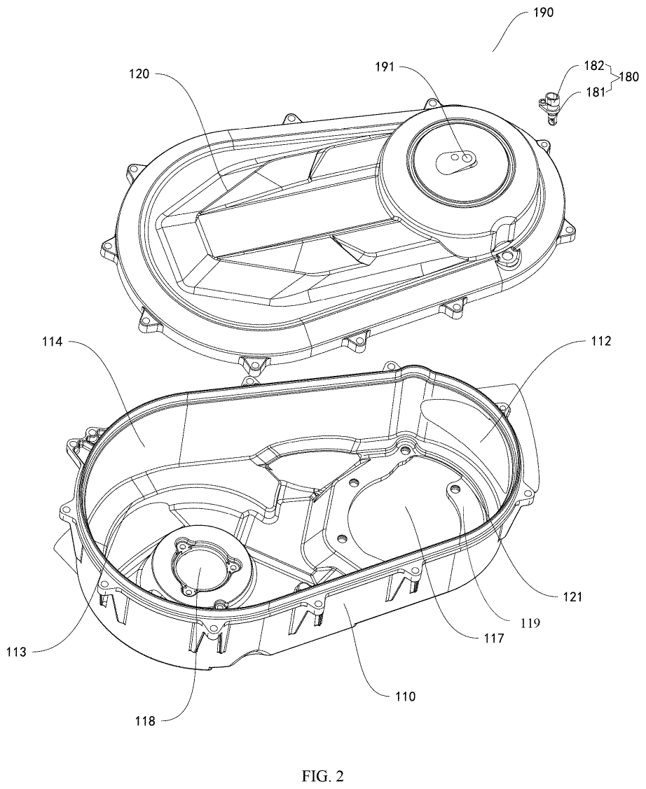

According to some embodiments of the present disclosure, as illustrated in FIGS. 1 and 2, the temperature detection device 180 further includes a body part 182, the temperature-sensing probe 181 is mounted to the body part 182, and the body part 182 is mounted to the transmission casing 190 and located outside the cavity 121. Thus, by mounting the body part 182 outside the cavity 121, internal space of the cavity 121 is saved and volume of the transmission casing 190 may be reduced, facilitating improvement of space utilization of the product.

According to some embodiments of the present disclosure, the temperature detection device 180 is mounted to at least one of the casing body 110 and the casing cover 120. The casing cover 120 defines a through opening 191, the temperature detection device 180 is mounted to the casing cover 120, and the temperature-sensing probe 181 is inserted into the cavity 121 via the through opening 191; or, the casing body 110 defines a through opening 191, the temperature detection device 180 is mounted to the casing body 110, and the temperature-sensing probe 181 is inserted into the cavity 121 via the through opening 191. Thus, coupling relationship between the temperature detection device 180 and casing cover 120 or between the temperature detection device 180 and casing body 110 can be more stable, and the structure is simple and easy to assemble, and facilitates insertion of the temperature-sensing probe 181 into the cavity 121.

According to some specific embodiments of the present disclosure, as illustrated in FIGS. 1 to 4, the transmission mechanism 130 includes a driving gear 132 and a driven gear 134. The driving gear 132 and the driven gear 134 is provided in the cavity 121, the driven gear 134 is drivingly coupled to the driving gear 132, and the driving gear 132 is closer to the air outlet 112 than the driven gear 134. Influence of the driving gear 132 on air flow of the cavity 121 is more critical, thus by arranging the driving gear 132 close to the air outlet 112, flow efficiency of air flow in the cavity 121 can be promoted, and adjustment efficiency of the temperature in the cavity 121 can be further improved.

According to some specific embodiments of the present disclosure, as illustrated in FIGS. 1 and 2, the air outlet 112 is located at a side away from the driven gear 134 in a radial direction of the of the driving gear 132. For example, the air outlet 112 is located at a side of the driving gear 132 in the radial direction of the driving gear 132, and the driven gear 134 is located at the other side of the driving gear 132 in the radial direction of the driving gear 132. The driving gear 132 is rotatable about its central axis, the driven gear 134 is rotatable about its central axis, and the driving gear 132 drives the air flow to move in its circumferential direction. The air outlet 112 and the driven gear 134 are located at radially opposite sides of the driving gear 132 such that the driving gear 132 is facilitated to drive the air flow to flow to the driven gear 134 and the air inlet 111, improving cooling efficiency of the driven gear 134 and flow efficiency of the air flow in the cavity 121. It could be understood that, the air outlet 112 and the driven gear 134 may be located at tangent lines of the driving gear 132, further improving cooling efficiency of the driven gear 134 and flow efficiency of the air flow in the cavity 121.

According to some specific embodiments of the present disclosure, as illustrated in FIGS. 1 to 4, the casing body 110 includes a bottom wall 113 and a side wall 114. The air inlet 111 is defined in the bottom wall 113, and the side wall 114 surrounds the bottom wall 113 along a circumferential direction of an outer circumferential edge of the bottom wall 113. The casing cover 120 is mounted to the side wall 114, and the air outlet 112 is defined in the side wall 114. The bottom wall 113 may be located at an axial side of the driving gear 132 (i.e., an axial side of the driven gear 134), and the side wall 114 may extend along the circumferential direction of the driving gear 132. Hence, when the driving gear 132 and the driven gear 134 rotate, the air flow is facilitated to enter via the bottom wall 113 and exit via side wall 114, and thus direction of the air flow is more stable, and air intake flow in the cavity 121 is more sufficient.

According to some specific embodiments of the present disclosure, as illustrated in FIG. 1, the air inlet 111 includes a driving gear air inlet 117 and a driven gear air inlet 118. A projection of the driving gear air inlet 117 in the axial direction of the driving gear 132 at least partially overlaps the driving gear 132, and the driving gear air inlet 117 may be located at an end of the driving gear 132 in the axial direction of the driving gear 132. A projection of the driven gear air inlet 118 in the axial direction of the driving gear 132 at least partially overlaps the driven gear 134, and the driven gear air inlet 118 may be located at an end of the driven gear 134 in the axial direction of the driving gear 132. By dividing the air inlet 111 into the driving gear air inlet 117 and the driven gear air inlet 118, the air inlet volume during rotation of the driving gear 132 and the driven gear 134 is ensured while the air inlet 111 of the casing body 110 is prevented from being too large, installation of parts in the casing body 110 is facilitated, structural strength of the casing body 110 is guaranteed, and impurities are prevented from entering the casing body 110. Therefore, the air inlet volume, the structural strength and the cleaness of the cavity 121 are balanced.

According to some specific embodiments of the present disclosure, as illustrated in FIG. 1, the side wall 114 includes a first air guiding wall 115 and a second air guiding wall 116. The first air guiding wall 115 and the second air guiding wall 116 are arranged oppositely, and the air outlet 112 is located between the first air guiding wall 115 and the second air guiding wall 116. The first air guiding wall 115 guides a portion of the air flow driven by the driving gear 132 to the driven gear 134, and the second air guiding wall 116 guides another portion of the air flow driven by the driving gear 132 and the air flow driving by the driven gear 134 to the air outlet 112.

By way of example, the driving gear 132 drives a portion of the air flow entering via the driving gear air inlet 117 to be guided along the first air guiding wall 115 to the driven gear 134, the driving gear 132 drives another portion of the air flow entering via the driving gear air inlet 117 to be guided along second air guiding wall 116 to the air outlet 112 and discharged from the cavity 121 via the air outlet 112. The driven gear 134 drives the air flow entering via the driven gear air inlet 118 and the above-described portion of the air flow entering via the driving gear air inlet 117 to be guided along the second air guiding wall 116 to the air outlet 112 and discharged from the cavity 121 via the air outlet 112.

According to some specific embodiments of the present disclosure, as illustrated in FIG. 1, the transmission 100 also includes a driving gear air guiding panel 140, and the driving gear air guiding panel 140 is mounted to the casing body 110 and located at the driving gear air inlet 117.

In some embodiments of the present disclosure, the driving gear air inlet 117 is provided with a collar 119 extends along its circumferential direction and protrudes towards the casing cover 120.

The driving gear air guiding panel 140, the collar 119 and the bottom wall 113 cooperatively define an air inlet chamber 142, and the air inlet chamber 142 constitutes a portion of the cavity 121. The air entering via the driving gear air inlet 117 can flow along the cavity 121, and will not be diffused. The cavity 121 may be internally provided a fan, and the air in the air inlet chamber 142 can be guided to the driving gear 132 by the fan to cool the driving gear 132, thereby improving cooling effect and reducing noises.

It is known by those skilled in the art that when the air flow volume is the same, the smaller the space, the greater the air flow speed. The space of the air inlet chamber 142 is far smaller than external space of the transmission 100, and hence provision of the air inlet chamber 142 can promote the speed of the air flow entering the cavity 121, and facilitate decrease of temperature in the cavity 121. Moreover, the driving gear air guiding panel 140 defines a threaded hole along its thickness, and the driving gear air guiding panel 140 is mounted in the cavity 121 by a threaded fastener passing though the threaded hole.

According to some specific embodiments of the present disclosure, the transmission 100 also includes a driving gear air inlet elbow pipe 150, a driven gear air inlet elbow pipe 160 and an air outlet straight pipe 170. The driving gear air inlet elbow pipe 150 is mounted to the casing body 110 and in communication with the driving gear air inlet 117, the driven gear air inlet elbow pipe 160 is mounted to the casing body 110 and in communication with the driven gear air inlet 118, and the air outlet straight pipe 170 is mounted to the casing body 110 and in communication with the air outlet 112. The driving gear air inlet elbow pipe 150 and the driven gear air inlet elbow pipe 160 are bent towards the same direction. The driving gear air inlet elbow pipe 150 and the driven gear air inlet elbow pipe 160 may be coupled to an air inlet pipeline of the whole vehicle, and the air outlet straight pipe 170 may be coupled to an air outlet pipeline of the whole vehicle.

The driving gear air inlet elbow pipe 150 and the driven gear air inlet elbow pipe 160 can facilitate air communication between the transmission casing 190 and the exterior of the vehicle, to guarantee air inlet efficiency. Moreover, the driving gear air inlet elbow pipe 150 and the driven gear air inlet elbow pipe 160 are bent towards the same direction, the arrangement of the pipelines are regular, and the inlet air flow is more concentrated, to prevent the inlet air flow from being interfered and hindered, ensure stability of the inlet air and ensure circulation efficiency of the air flow in the transmission 100. The air outlet straight pipe 170 can facilitate air communication between the transmission casing 190 and the exterior of the vehicle, to guarantee air outlet efficiency. Moreover, the outlet air flow is more concentrated, to prevent the outlet air flow from being interfered and hindered, ensure stability of the outlet air and further ensure circulation efficiency of the air flow in the transmission 100.

By way of example, the temperature-sensing probe 181 may also be inserted into the air outlet straight pipe 170 for detection of the temperature in the air outlet straight pipe 170. The temperature detection device 180 may also be mounted to the air outlet straight pipe 170.

According to some specific embodiments of the present disclosure, the transmission 100 is a continuously variable transmission (CVT). The continuously variable transmission can change a transmission ratio of a transmission system according to actual situations of the vehicle and the road, to make an engine work within optimal range in terms of power and fuel consumption rate, and to ensure continuous and smooth power transmission. However, the continuously variable transmission realizes the transmission through use of sliding friction. The friction will cause high temperature and wear and tear, and the high temperature will affect lubrication of the continuously variable transmission to intensify the wear and tear. Therefore, the continuously variable transmission needs good pipeline arrangement even more, to guarantee cooling effect.

A transmission 100 according to other embodiments of the present disclosure is described below with reference to the accompanying drawings.

As illustrated in FIGS. 1 to 4, the transmission 100 according to embodiments of the present disclosure includes a transmission casing 190, an air outlet straight pipe 170, and a transmission mechanism 130 and a temperature detection device 180.

The transmission casing 190 defines a cavity 121, and the transmission casing 190 defines an air inlet 111 and an air outlet 112 that are in communication with the cavity 121. At least a part of the transmission mechanism 130 is provided in the cavity 121, the air outlet straight pipe 170 is coupled to the air outlet 112 of the transmission casing 190, and the controller 300 is communicated with the temperature detection device 180. The temperature detection device 180 includes a temperature-sensing probe 181. The temperature-sensing probe 181 is inserted into at least one of the cavity 121 and the air outlet straight pipe 170. The temperature detection device 180 may be a temperature sensor.

By way of example, the air outlet straight pipe 170 may be coupled to an air outlet straight pipeline of the whole vehicle. The provision of the air outlet straight pipe 170 can facilitate air communication between the transmission casing 190 and the exterior of the vehicle, to guarantee air outlet efficiency. Moreover, the outlet air flow is more concentrated, to prevent the outlet air flow from being interfered and hindered, ensure stability of the outlet air and further ensure circulation efficiency of the air flow in the transmission 100.

In the transmission 100 according to embodiments of the present disclosure, the transmission casing 190 defines the cavity 121, the transmission casing 190 defines the air inlet 111 and the air outlet 112 in communication with the cavity 121, and at least a part of the transmission mechanism 130 is provided in the cavity 121. Thus, provision of the transmission mechanism 130 can facilitate achievement of speed change of the vehicle, and complete normal operation of the vehicle. Furthermore, at least a part of the transmission mechanism 130 is provided in the cavity 121, and the cavity 121 is in communication with the air inlet 111 and the air outlet 112 separately. Thus, air flow efficiency of the cavity 121 can be promoted, reduction in operational temperature of the transmission mechanism 130 can be facilitated, and reliability of the vehicle can be improved.

In addition, the air outlet straight pipe 170 is coupled to the air outlet 112 of the transmission casing 190. The transmission 100 also includes the temperature detection device 180, the temperature detection device 180 includes the temperature-sensing probe 181, and the temperature-sensing probe 181 is inserted into at least one of the cavity 121 and the air outlet straight pipe 170. The temperature-sensing probe 181 can detect the temperature in the cavity 121 or the air outlet straight pipe 170 in real time, and the temperature detection device 180 can feed back the detected temperature in the cavity 121 or the air outlet straight pipe 170 to a controller 300, such as an electronic control unit (ECU), such that the electronic control unit can adjust operation state of the vehicle. For example, when the temperature in the cavity 121 or the air outlet straight pipe 170 is too high, the electronic control unit may control an engine of the vehicle to stop or reduce its speed, to reduce the temperature in the cavity 121 and improve driving safety. Thus, the provision of the temperature-sensing probe 181 can facilitate adjustment of operational state of the vehicle itself, reduce probability of failure of the vehicle, and improve driving safety.

In this way, the transmission 100 according to embodiments of the present disclosure can detect temperature to facilitate adjustment of operational state of the vehicle itself and has advantages of low probability of failure of the vehicle, and high driving safety, etc.

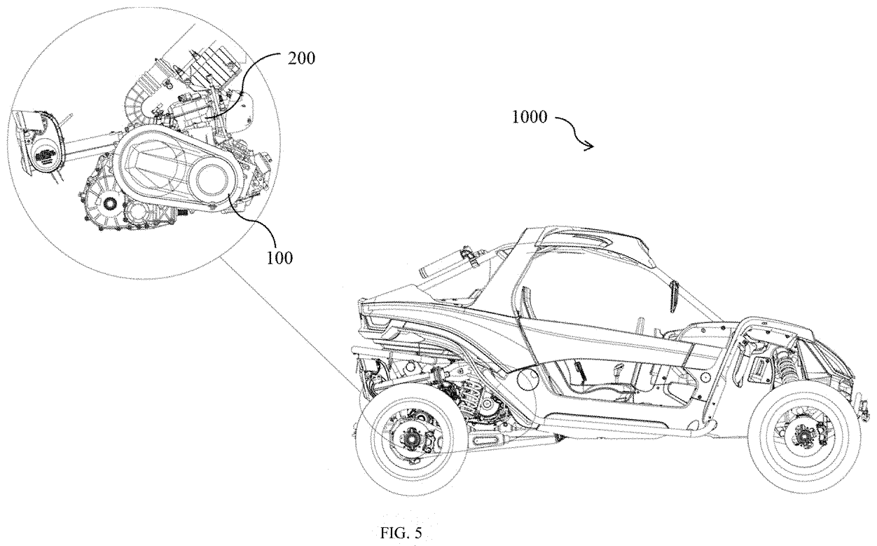

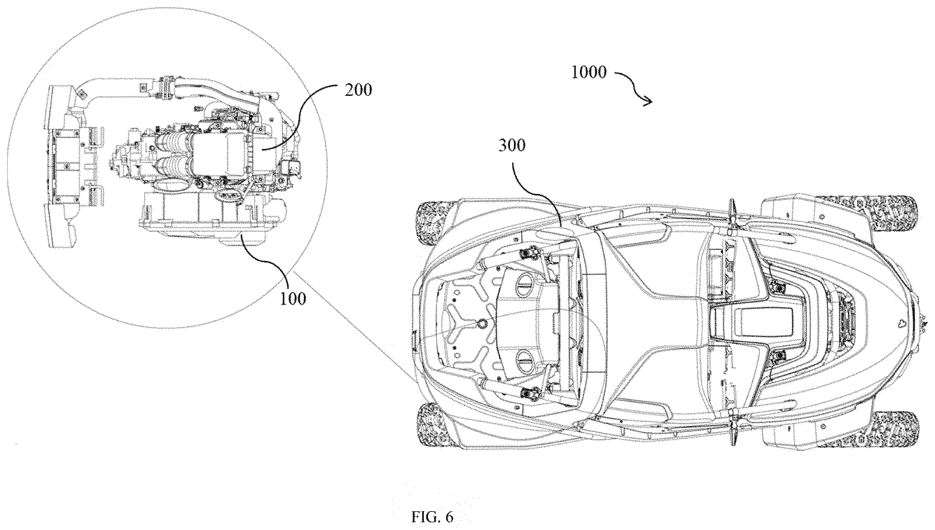

An all-terrain vehicle 1000 according to embodiments of the present disclosure will be described below with reference to FIGS. 5 and 6. The all-terrain vehicle 1000 includes a transmission 100 according to above embodiments of the present disclosure.

The all-terrain vehicle 1000 may also include a power device 200 and a controller 300. The controller 300 is communicated with the power device 200 and the transmission 100 (such as, its temperature detection device) separately.

The all-terrain vehicle 1000 according to embodiments of the present disclosure having the transmission 100 according to the above embodiments of the present disclosure has advantages of simple pipeline arrangement, high concentration and high space utilization as well as low probability of failure of the vehicle, and high driving safety, etc.

Other constitutions and operations of the transmission 100 and the all-terrain vehicle 1000 according to embodiments of the present disclosure are well known by those skilled in the art, which will not be elaborated herein.

Reference throughout this specification to “an embodiment,” “some embodiments,” “an illustrative embodiment” “an example,” “a specific example,” or “some examples,” means that a particular feature, structure, material, or characteristic described in connection with the embodiment or example is included in at least one embodiment or example of the present disclosure. In the specification, representative expression of the above-described terms do not necessarily indicate the same embodiment or example.

Although embodiments of the present disclosure have been shown and illustrated, it shall be understood by those skilled in the art that various changes, modifications, alternatives and variants without departing from the principle of the present disclosure are acceptable. The scope of the present disclosure is defined by the claims or the like.

What is claimed is:

1. A transmission, comprising:
a casing body defining an air inlet and an air outlet;
a casing cover mounted to the casing body, the casing cover and the casing body cooperatively defining a cavity in communication with the air inlet and the air outlet separately; and
a transmission mechanism having at least a part provided in the cavity.

2. The transmission according to claim 1, wherein the casing body comprises:
a bottom wall, the air inlet being defined in the bottom wall; and
a side wall surrounding the bottom wall in a circumferential direction of an outer circumferential edge of the bottom wall, the casing cover being mounted to the side wall, and the air outlet being defined in the side wall.

3. The transmission according to claim 2, wherein the transmission mechanism comprises:
a driving gear provided in the cavity; and
a driven gear provided in the cavity and drivingly coupled to the driving gear, and the driving gear being closer to the air outlet than the driven gear.

4. The transmission according to claim 3, wherein the air outlet is located at a side away from the driven gear in a radial direction of the driving gear.

5. The transmission according to claim 3, wherein the side wall comprises a first air guiding wall and a second air guiding wall arranged oppositely, and the air outlet is located between the first air guiding wall and the second air guiding wall.

6. The transmission according to claim 3, wherein the air inlet comprises:
a driving gear air inlet, a projection of the driving gear air inlet in an axial direction of the driving gear at least overlapping the driving gear; and
a driven gear air inlet, a projection of the driven gear air inlet in the axial direction of the driving gear at least overlapping the driven gear.

7. The transmission according to claim 6, further comprising:
a driving gear air inlet elbow pipe mounted to the casing body and in communication with the driving gear air inlet;
a driven gear air inlet elbow pipe mounted to the casing body and in communication with the driven gear air inlet; and
an air outlet straight pipe mounted to the casing body and in communication with the air outlet,
wherein the driving gear air inlet elbow pipe and the driven gear air inlet elbow pipe are bent towards a same direction.

8. The transmission according to claim 2, further comprising:
a driving gear air guiding plate mounted to the casing body and defining an air inlet chamber in communication with the driving gear air inlet in the cavity.

9. The transmission according to claim 8, wherein the driving gear air inlet is provided with a collar extending in its circumferential direction and protruding towards the casing cover, and the driving gear air guiding plate, the collar and the bottom wall define the air inlet chamber.

10. A transmission, comprising:
a transmission casing defining a cavity therein and defining an air inlet and an air outlet in communication with the cavity;
a transmission mechanism having at least a part provided in the cavity;
an air outlet straight pipe coupled to the air outlet of the transmission casing; and
a temperature detection device comprising a temperature-sensing probe inserted into at least one of the air outlet straight pipe and the cavity.

11. The transmission according to claim 10, wherein the temperature detection device is located at the air outlet.

12. The transmission according to claim 10, wherein the temperature detection device further comprises a body part, the temperature-sensing probe is mounted to the body part, and the body part is mounted to the transmission casing and located outside the cavity.

13. The transmission according to claim 10, wherein the transmission casing comprises:
a casing body defining the air inlet and the air outlet; and
a casing cover mounted to the casing body, the casing cover and the casing body cooperatively defining the cavity,
wherein the temperature detection device is mounted to at least one of the casing body and casing cover.

14. The transmission according to claim 13, wherein the casing cover defines a through opening, the temperature detection device is mounted to the casing cover and the temperature-sensing probe is inserted into the cavity via the through opening; or
the casing body defines a through opening, the temperature detection device is mounted to the casing body and the temperature-sensing probe is inserted into the cavity via the through opening.

15. The transmission according to claim 13, wherein the casing body comprises:
a bottom wall, the air inlet being defined in the bottom wall; and
a side wall surrounding the bottom wall in a circumferential direction of an outer circumferential edge of the bottom wall, the casing cover being mounted to the side wall, and the air outlet being defined in the side wall.

16. The transmission according to claim 15, wherein the transmission mechanism comprises:
a driving gear provided in the cavity; and
a driven gear provided in the cavity and drivingly coupled to the driving gear, and the driving gear being closer to the air outlet than the driven gear.

17. The transmission according to claim 16, wherein the air outlet is located at a side away from the driven gear in a radial direction of the driving gear.

18. The transmission according to claim 17, wherein the side wall comprises a first air guiding wall and a second air guiding wall arranged oppositely, and the air outlet is located between the first air guiding wall and the second air guiding wall.

19. The transmission according to claim 17, wherein the air inlet comprises:
a driving gear air inlet, a projection of the driving gear air inlet in an axial direction of the driving gear at least overlapping the driving gear; and
a driven gear air inlet, a projection of the driven gear air inlet in the axial direction of the driving gear at least overlapping the driven gear.

20. An all-terrain vehicle, comprising:
a power device;
a transmission comprising:
a transmission casing defining a cavity therein and defining an air inlet and an air outlet in communication with the cavity,
a transmission mechanism having at least a part provided in the cavity,
an air outlet straight pipe coupled to the air outlet of the transmission casing, and
a temperature detection device comprising a temperature-sensing probe inserted into at least one of the air outlet straight pipe and the cavity; and
a controller communicated with the power device and the temperature detection device separately.
